(19) United States
(12) Patent Application Publication
(10) Pub. No.: US 2014/0286855 A1
(43) Pub. Date: Sep. 25, 2014

(54) Catalyst for direct synthesis of hydrogen peroxide comprising zirconium oxide

(71) Applicant: SOLVAY SA, Brussels (BE)

(72) Inventors: Frédérique Desmedt, Brussels (BE); Paul Deschrijver, Lennik (BE); Yves Vlasselaer, Leefdaal (BE); Francine Janssens, Vilvoorde (BE)

(21) Appl. No.: 14/355,231

(22) PCT Filed: Oct. 26, 2012
(86) PCT No.: PCT/EP2012/071213

§ 371 Date: Apr. 30, 2014

(30) Foreign Application Priority Data
Nov. 7, 2011 (EP) 11188055.5

(51) Int. Cl. B01J 23/52; B01J 23/44; C01B 15/029; B01J 23/46

(52) U.S. Cl. CPC B01J 23/52; B01J 23/464; B01J 23/44; C01B 15/029
USPC 423/584; 502/325; 502/330; 502/339; 502/242

(57) ABSTRACT

A catalyst comprising: a platinum group metal, silver, gold, or a mixture thereof, and a carrier containing an oxide other than zirconium oxide and a precipitate layer of zirconium oxide onto the oxide other than zirconium oxide, as well as their uses in production of hydrogen peroxide. A process for producing hydrogen peroxide, comprising reacting hydrogen and oxygen in the presence of such catalyst in a reactor, and a process for producing such catalyst.

This application claims priority of the European application No. 11188055.5 filed on Nov. 7, 2011, the whole content of this application being incorporated herein by reference for all purposes.

Should the disclosure of any patents, patent applications, and publications which are incorporated herein by reference conflict with the description of the present application to the extent that it may render a term unclear, the present description shall take precedence.

### TECHNICAL FIELD

This invention is related to a catalyst comprising: a platinum group metal, silver, gold, or a mixture thereof, and a carrier containing zirconium oxide, and an oxide other than zirconium oxide, as well as a process for producing the catalyst of the invention. The invention also relates to its use in production of hydrogen peroxide and a process for producing hydrogen peroxide, comprising reacting hydrogen and oxygen in the presence of the catalyst according to the invention.

### STATE OF THE ART

Hydrogen peroxide is a highly important commercial product widely used as a bleaching agent in the textile or paper manufacturing industry, a disinfecting agent and basic product in the chemical industry and in the peroxide compound production reactions (sodium perborate, sodium percarbonate, metallic peroxides or percarboxyl acids), oxidation (amine oxide manufacture), epoxidation and hydroxylation (plasticizing and stabilizing agent manufacture). Commercially, the most common method to produce hydrogen peroxide is the “anthraquinone” process. In this process, hydrogen and oxygen react to form hydrogen peroxide by the alternate oxidation and reduction of alkylated anthraquinones in organic solvents. A significant disadvantage of this process is that it is costly and produces a significant amount of by-products that must be removed from the process.

One highly attractive alternative to the anthraquinone process is the production of hydrogen peroxide directly by reacting hydrogen and oxygen in the presence of metal catalysts supported on various oxides such as silica as a catalyst carrier.

However, in these processes, when a catalyst based on silica as carrier is used for the direct synthesis of hydrogen peroxide, the reaction product, i.e., hydrogen peroxide was not efficiently produced since the production of water as a by-product was very high and even higher than the hydrogen peroxide production after a certain period of time. To prevent these drawbacks, alternative processes with zirconium oxide (ZrO₂) instead of silica have been proposed (EP 0537836 A1, U.S. Pat. No. 6,387,346 B1). While those supported onto the zirconium oxide-based carriers exhibited nice productivities and concentration of H₂O₂ of 4 wt. % in water, unfortunately, they showed a very poor mechanical behavior of this catalyst since they were fragile and had a significant attrition. Another alternative (US 2007/0142651 A1) is the use of a catalyst comprising a polymer-encapsulated combination of noble metal and ion exchange resin.

U.S. Pat. No. 4,240,933 relates to a silica supported palladium catalyst and its use in catalytic hydrogenation of alkylanthraquinones.

U.S. Pat. No. 4,521,531 also relates to a catalyst for the anthraquinone-hydroquinone method of preparing hydrogen peroxide. The catalyst is a palladium-on-silica catalyst.

U.S. Pat. No. 5,849,256 and U.S. Pat. No. 5,145,825 relate to oxidation catalysts useful in purifying exhaust and waste gases capable of converting carbon monoxide to carbon dioxide in the presence of sulfur compounds. The catalytic material comprises a platinum component being supported on a refractory inorganic oxide support material, such as zirconium-treated silica.

However, those processes still do not exhibit sufficiently high productivity and selectivity for producing hydrogen peroxide while maintaining good mechanical resistance, and in consequence there have been demands for a novel catalyst which does not exhibit such disadvantages.

### DETAILED DESCRIPTION OF THE INVENTION

The expression “carrier” intends herein to denote the material, usually a solid with a high surface area, to which a catalytic compound is affixed and the carrier may be inert or participate in the catalytic reactions.

The object of the invention is to provide a catalyst for producing hydrogen peroxide from hydrogen and oxygen which does not present the above disadvantages and which enables to efficiently obtain hydrogen peroxide while maintaining good mechanical properties. Another object of the invention is to provide a process for producing the catalyst of the invention, and to provide an efficient process for producing hydrogen peroxide using the catalyst of the invention.

The present invention therefore relates to a catalyst comprising a platinum group metal, silver or gold, and a carrier containing an oxide other than zirconium oxide and a precipitate layer of zirconium oxide onto the oxide other than zirconium oxide. The present invention is also directed to its use in production of hydrogen peroxide, a process for producing hydrogen peroxide, comprising: reacting hydrogen and oxygen in the presence of the catalyst of the invention in a reactor, as well as a process for producing the catalyst of the invention.

The inventors have surprisingly discovered that by using a catalyst comprising a carrier containing an oxide other than zirconium oxide and a precipitate layer of zirconium oxide onto the oxide other than zirconium oxide such as silica, both high-productivity and selectivity are obtained as well as showing very good mechanical behavior in the direct reaction between hydrogen and oxygen.

Therefore, in accordance with a first aspect of the present invention, a catalyst is provided to obtain hydrogen peroxide comprised of a platinum group metal, silver, gold, or a mixture thereof, and a carrier containing an oxide other than zirconium oxide and a precipitate layer of zirconium oxide onto the oxide other than zirconium oxide.

In one preferred embodiment of the present invention, the catalyst comprises at least one metal selected from among the platinum group (comprised of ruthenium, rhodium, palladium, osmium, iridium, platinum), silver, gold, or any combination of these metals, preferably selected from the group consisting of ruthenium, rhodium, palladium, osmium, iridium, and platinum. In a more preferred embodiment, the catalyst comprises a palladium metal and in particular a combination of palladium with another metal (for example, platinum, ruthenium or gold). In a more specific embodiment, the catalyst comprises palladium alone or a combination of palladium and gold. Preferably, the platinum group metal, silver or gold is present in reduced form, such as Pd⁰, Pt⁰, Rh⁰, Au⁰ etc.

The amount of metal supported to the carrier can vary in a broad range, but be preferably comprised from 0.001 to 10 wt. %, more preferably from 0.1 to 5 wt. % and most preferably from 0.5 to 3 wt. %, each based on the weight of the carrier. The addition of the metal to the carrier can be performed using any of the known preparation techniques of supported metal catalyst, e.g. impregnation, adsorption, ionic exchange, etc. For the impregnation, it is possible to use any kind of inorganic or organic salt or the metal to be impregnated that is soluble in the solvent used in addition to the metal. Suitable salts are for example halide such as chlorides, acetate, nitrate, oxalate, etc.

One of the essential features of the present invention resides in the use of a carrier containing an oxide other than zirconium oxide and a precipitate layer of zirconium oxide onto the oxide other than zirconium oxide along with a gold or platinum group metal or a mixture thereof to achieve the purpose of the invention. It has indeed been found that by using the catalyst according to the invention hydrogen peroxide is efficiently obtained while maintaining good mechanical properties, with improved productivity and selectivity towards the reaction product which is hydrogen peroxide. Moreover, this selectivity remains stable even at high concentration of hydrogen peroxide, for example higher than 10% by weight and it remains quite stable during the entire process.

The oxide other than zirconium oxide may be any oxide known in the art but preferably is selected from a group consisting of silica, alumina, titanium oxide, niobium oxide, barium oxide, and mixtures thereof. In a preferred embodiment, the oxide other than zirconium oxide comprises silica, and the carrier comprises silica on which zirconium oxide is precipitated to form a precipitate layer. The presence of the precipitate layer of zirconium oxide such as ZrO₂ is preferred since it increases the mechanical resistance of the catalyst which is one of essential feature of catalysts for the industrial use.

In specific embodiments of the present invention, the amount of the oxide other than zirconium oxide is from 30 to 99 wt. %, more preferably from 50 to 98 wt. % and most preferably from 70 to 95 wt. %, each based on the total weight of oxides in the carrier.

The preparation of the carrier containing an oxide other than zirconium oxide and a precipitate layer of zirconium oxide onto the oxide other than zirconium oxide may be accomplished by a variety of techniques known in the art. One such method involves impregnating an oxide other than zirconium oxide with a zirconium compound (e.g., ZrOCl₂), optionally followed by drying. The zirconium compounds include any suitable zirconium hydroxide, zirconium alkoxide, or zirconium oxyhalide (such as ZrOCl₂). Alternatively, the carrier is prepared by cogelling a mixture of a zirconium salt and a sol of an oxide other than zirconium oxide by conventional methods of preparing metal supported catalyst compositions. Other techniques for incorporating an oxide or hydroxide of zirconium on an oxide other than zirconium oxide such as dry-mixing, co-precipitation, impregnation and ion-exchange are also suitably employed. In preferred embodiments zirconium oxide (ZrO₂) is precipitated onto silica to form a mixture of those oxides.

These oxides can essentially be amorphous like a silica gel or can be comprised of an orderly structure of mesopores, such as, for example, of types including MCM-41, MCM-48, SBA-15, among others or a crystalline structure, like a zeolite.

The platinum group metal, silver or gold used in the invention may be deposited by various ways known in the art. For example, the metal can be deposited by dipping the carrier to a solution of halides of the metal followed by reduction. In more specific embodiments, the reduction is carried out in the presence of a reducing agent, preferably gaseous hydrogen at high temperature.

The catalyst according to the invention has a large specific surface area determined by the BET method, generally greater than 20 m²/g, preferably greater than 100 m²/g. Moreover, the catalyst can essentially have an amorphous structure. In particular the zirconium oxide and/or the oxide other than zirconium oxide can have an amorphous structure. Preferably, the zirconium oxide and the oxide other than zirconium oxide can have an amorphous structure.

In the second aspect of this invention, the invention is also directed to the use of the catalyst according to the invention in production of hydrogen peroxide by direct synthesis. In the process of the invention, hydrogen and oxygen (as purified oxygen or air) are reacted continuously over a catalyst in the presence of a liquid solvent in a reactor to generate a liquid solution of hydrogen peroxide. The catalyst is then used for the direct synthesis of hydrogen peroxide in a three phase's system: the catalyst (solid) is put in a solvent (alcohol or water) and the gases (H₂, O₂ and an inert gas) are bubbled in the suspension in presence of stabilizing additives (halides and/or inorganic acid). In other embodiments, the catalyst of the invention may be also used for the synthesis of hydrogen peroxide by the anthraquinone process.

In the third aspect of the invention, a process for producing hydrogen peroxide, comprising: reacting hydrogen and oxygen in the presence of the catalyst according to the invention in a reactor, is provided. The process of this invention can be carried out in continuous, semi-continuous or discontinuous mode, by the conventional methods, for example, in a stirred tank reactor with the catalyst particles in suspension, in a basket-type stirred tank reactor, etc. Once the reaction has reached the desired conversion levels, the catalyst can be separated by different known processes, such as, for example, by filtration if the catalyst in suspension is used, which would afford the possibility of its subsequent reuse. In this case the amount of catalyst used is that necessary to obtain a concentration 0.01 to 10 wt. % regarding the solvent and preferably being 0.1 to 5 wt. %. The concentration of the obtained hydrogen peroxide according to the invention is generally higher than 5 wt. %, preferably higher than 8 wt. %, most preferably higher than 10 wt. %.

In the last aspect of the invention, the invention relates to a process for producing the catalyst of the invention, comprising: (i) adding to an oxide other than zirconium oxide a precursor of zirconium oxide to form a homogeneous mixture, (ii) converting the precursor of zirconium oxide to zirconium oxide to produce a carrier, and (iii) depositing a platinum group metal, silver, gold, or a mixture thereof onto the carrier.

In preferred embodiment, the precursor of zirconium oxide is an oxyhalide of zirconium, preferably zirconium oxychloride. The precursor is converted, for example after hydrolysis followed by heat treatment, to zirconium oxide, which can be precipitated onto the support of an oxide other than zirconium oxide to produce a carrier. A gold or platinum group metal such as palladium which acts as active material in the direct synthesis of hydrogen peroxide is deposited on these oxides of zirconium.

Throughout the description and the claims, the word “comprises” and the variations thereon do not intend to exclude other technical features, additives, components or steps. For the experts in this field, other objects, advantages and characteristics of the invention will be inferred in part from the description and in part from the embodiment of the invention. The following examples are provided for illustrative purposes and are not intended to be limiting of the present invention.

### EXAMPLES

### Example 1

In a beaker of 1 L containing 400 mL of demineralized water, 2 drops of NH₄OH 25 wt. % aqueous solution were added to reach a pH of around 8.5. 50.01 g of silica were introduced and mechanically stirred at around 260 rpm of the stirring speed. The suspension was heated at 50° C. 14.73 g of ZrOCl₂ were dissolved at room temperature in 26.75 g of demineralized water. When the temperature was stable, pH was rectified. The solution of ZrOCl₂ was introduced slowly with a syringe pump (all the solution in +/−30 minutes). At the same time, pH was maintained between 8.4 and 8.5 by adding some drops of NH₄OH 25 wt. %. The suspension was then kept under stirring at 50° C. for one hour. After storing the suspension at room temperature during 20 minutes without stirring, it was filtered and the resultant solids were washed with 500 mL demineralized water, and dried for 24 hours at 95° C. Then the solid was calcined at 600° C. during 3 hours.

1 g of a solution of palladium chloride (19.9 wt. % in Pd) was diluted in 19 g of demineralized water. The solution was put in contact with 20 g of the obtained solid and was well mixed until all the liquid phase was adsorbed by the carrier solid. The mixture was dried overnight at 100° C. Palladium was reduced under influence of a mixture of hydrogen and nitrogen at 125° C. during 8 hours. This catalyst was called catalyst A.

The resultant catalyst A had a surface area determined by BET of 325 m²/g and was amorphous as determined by the X-ray diffraction (XRD) analysis. The diameter of the particles determined by the scanning electron microscope (SEM) was around 200 micrometers.

### Example 2

A catalyst was prepared as in Example 1, except that 400 mL of water, 15 g of zirconium oxychloride and 50 g of SiO₂ were used. This catalyst was called catalyst B.

### Comparative Example 1

A catalyst based on silica was prepared by incipient wetness method: 1 g of a solution of palladium chloride (19.9 wt. % in Pd) was diluted in 19 g of demineralized water. The solution was put in contact with 20 g of silica. The resultant solid was dried overnight at 75° C.

Palladium was reduced under influence of a mixture of hydrogen and nitrogen at 125° C. during 8 hours. Pd content as determined by inductively coupled plasma optical emission spectrometry (ICP-OES) reached 0.91 wt. %. This catalyst was called catalyst C.

Catalyst C had a surface area determined by BET of 325 m²/g and was amorphous (XRD). The diameter of the particles determined by SEM was around 200 micrometers.

### Comparative Example 2

A catalyst based on zirconia was prepared by incipient wetness method: 0.4685 g of palladium chloride was dissolved in 2 ml of water at 50° C. under stirring (in presence of some drops of HC135 wt. % solution). The solution was put in contact with 14.86 g of zirconia. Catalyst was dried overnight at 95° C.

Palladium was reduced under influence of a mix hydrogen/nitrogen at 125° C. during 8 hours. Pd content as determined by ICP-OES reached 1.90 wt. %. This catalyst was called catalyst D.

Catalyst D had a surface area determined by BET of 33 m²/g and was mainly monoclinic (XRD). The diameter of the particles determined by SEM was around 20 micrometers.

### Example 3

In a SS316L 250 mL reactor, methanol (150 g), hydrogen bromide (16 ppm), ortho-phosphoric acid (H₃PO₄) and a catalyst (0.54 g) obtained in Examples 1 and 2 and Comparative Examples 1 and 2, respectively, were introduced. The amount of o-phosphoric acid was calculated to obtain a final concentration of 0.1 M. The reactor was cooled to 5° C. and the working pressure was at 50 bars (obtained by introduction of nitrogen). The reactor was flushed all the time of the reaction with the mixture of gases: hydrogen (3.5% Mol)/oxygen (25.25% Mol)/nitrogen (71.25% Mol). The total flow was 2574 mlN/min.

When the gas phase out was stable (GC on line), the mechanical stirrer was started at 1500 rpm. Gas Chromatography (GC) on line analyzed every 10 minutes the gas phase out. Liquid samples were taken to measure hydrogen peroxide and water concentration. Hydrogen peroxide was measured by redox titration with cerium sulfate. Water was measured by the Karl-Fisher titration method. The results are summarized Table 1.

TABLE 1

| | Catalyst | Catalyst | Catalyst | Catalyst |
|---|---|---|---|---|
| | A | B | C | D |
| Methanol (g) | 150.67 | 149.92 | 150.49 | 151.12 |
| HBr (ppm) | 16 | 16 | 51 | 16 |
| H₃PO₄ (g) | 2.20 | 2.03 | / | 2.52 |
| Catalyst (g) | 0.5470 | 0.5609 | 2.6675 | 0.5554 |
| Hydrogen | 3.50 | 3.50 | 3.51 | 3.50 |
| (mol. %) | | | | |
| Oxygen | 25.25 | 25.05 | 35.06 | 25.25 |
| (mol. %) | | | | |
| Nitrogen | 71.25 | 71.45 | 61.43 | 71.25 |
| (mol. %) | | | | |
| Total flow | 2574 | 2567 | 2567 | 2574 |
| (mlN/min) | | | | |
| Speed (rpm) | 1500 | 1500 | 1500 | 1500 |
| Contact time | 360 | 240 | 225 | 360 |
| (Min) | | | | |
| Hydrogen | 4.36 | 3.51 | 2.48 | 4.37 |
| peroxide fin (wt. %) | | | | |
| Water fin | 4.52 | 4.63 | 5.31 | 3.31 |
| (wt. %) | | | | |
| Conversion | 25.2 | 39.0 | 46.0 | 27.9 |
| fin (%) | | | | |
| Selectivity | 33.9 | 31.7 | 19.9 | 41.2 |
| fin (%) | | | | |
| Productivity | 2804 | 3395 | 1207 | 3068 |
| fin (mol H₂O₂/(kg | | | | |
| of Pd*h)) | | | | |

### Example 4

### Test Procedure for Attrition

The following equipments were used for determining attrition values of materials in the invention:
Sieve shaking machine, for instance: Rotap—International Combustion Ltd, Derby, UK.
Test sieves: 200 mm diameter, aperture sizes 106 μm and 63 μm, complying with ISO 565
Balance capable to weigh to ±0.1 g.
Attrition apparatus: a glass tube equipped with a P4 filter at the bottom. Gaz goes through the filter and fluidized the solid.
25 mm diameter glass tubing with associated gaskets and flanges
Soxhlet thimbles, 25 mm diameter
Orifice plate stainless steel, with a 0.4 mm hole drilled centrally (drill the plate to match the flanges)
Flow meter, graduated in litres per minute.

About 30 g of the catalyst samples obtained in Examples and Comparative examples were placed on the 106 μm sieve. The sieves were placed on the shaking device and the samples were sieved for 10 minutes, and 25.0 g of the samples retained on the 106 μm sieve were transferred to the attrition apparatus. The dust collector (Soxhlet thimble) was placed on the top of the glass tube and the timer button was set to allow the air to pass into the attrition tube for 30 minutes. The contents of the attrition tube and dust collector were transferred into the nest of sieves followed by sieving for 10 minutes. The attrition values were determined by the following equation:

Attrition (%)=W1/Wp×100
where W1: the weight of the sample having a size smaller than 63 μm
Wp: the total weight of all sieves.

The attrition values of the catalysts of Example 1 and Comparative examples 1 and 2 were summarized in Table 2.

TABLE 2

| | Attrition, wt. % |
|---|---|
| Catalyst A (Example 1) | 5.8 |
| Catalyst C (Comparative Example 1) | 3.1 |
| Catalyst D (Comparative Example 2) | 61.7 |

The high attrition value of Catalyst D, which is a factor reflecting the degree of losses of materiel within a specified period of time, indicates that the catalyst of the invention is mechanically stable/resistant and is thus more suitable for industrial use.

Although this invention has been described broadly and also identifies specific preferred embodiments, it will be understood that modifications and variations may be made within the scope of the invention as defined by the following claims.

### Example 5

### Bi-Metallic Catalysts

Several bi-metallic catalysts have been prepared following the procedure described in the example 1. The catalysts prepared are described in the table 3.

TABLE 3

| | Pd | Other metal |
|---|---|---|
| | content, % Wt | content, % Wt |
| Catalyst E: | 2.49 | 2.28 |
| Pd/Au | | |
| Catalyst F: | 0.99% | 0.07% |
| Pd/Pt | | |
| Catalyst G: | 2.61 | 0.82 |
| Pd/Rh | | |

### Example 6

### Bi-Metallic Catalysts Tests

The bi-metallic catalysts have been tested in the same conditions as described in the example 2. The results are described in the table 4 and compared with the catalyst A.

TABLE 4

| | Catalyst | Catalyst | Catalyst | Catalyst |
|---|---|---|---|---|
| | A | E | F | G |
| Methanol (g) | 150.67 | 150.07 | 150.56 | 219.82 |
| HBr (ppm) | 16 | 16 | 35 | 16 |
| H₃PO₄ (g) | 2.20 | 2.20 | 2.20 | 3.23 |
| Catalyst (g) | 0.5470 | 0.5506 | 1.3608 | 0.801 |
| Hydrogen | 3.6 | 3.6 | 3.6 | 3.6 |
| (mol. %) | | | | |
| Oxygen | 55 | 55 | 55 | 55 |
| (mol. %) | | | | |
| Nitrogen | 41.4 | 41.4 | 41.4 | 41.4 |
| (mol. %) | | | | |
| Total flow | 2574 | 2574 | 2710 | 3975 |
| (mlN/min) | | | | |
| Speed (rpm) | 1500 | 1500 | 1500 | 1500 |
| Contact time | 240 | 240 | 240 | 240 |
| (Min) | | | | |
| Hydrogen | 6.0 | 8.3 | 7.7 | 6.2 |
| peroxide fin (wt. %) | | | | |
| Water fin | 2.8 | 3.1 | 6.1 | 2.1 |
| (wt. %) | | | | |
| Conversion | 35.6 | 48.5 | 57.7 | 31.7 |
| fin (%) | | | | |
| Selectivity | 53 | 50 | 40 | 58 |
| fin (%) | | | | |
| Productivity | 4117 | 5277 | 4751 | 4341 |
| fin (mol H₂O₂/(kg | | | | |
| of Pd*h)) | | | | |

We clearly observe a higher productivity and a better selectivity when a Pd/Au catalyst based on ZrOx/silica is used instead of pure Pd on ZrOx/silica.

1. A catalyst comprising at least one metal selected from the group consisting of a platinum group metal, silver, gold, and any mixture thereof, and a carrier containing an oxide other than zirconium oxide and a precipitate layer of zirconium oxide onto said oxide other than zirconium oxide.

2. The catalyst according to claim 1, wherein said catalyst comprises a platinum group metal selected from the group consisting of ruthenium, rhodium, palladium, osmium, iridium, and platinum.

3. The catalyst according to claim 1, wherein said catalyst comprises palladium or a combination of palladium with another metal.

4. The catalyst according to claim 1, wherein said carrier contains from 30 to 99 wt. % of the oxide other than zirconium oxide, based on the total weight of the oxides.

5. The catalyst according to claim 1, wherein said oxide other than zirconium oxide is selected from the group consisting of silica, alumina, niobium oxide, titanium oxide, barium oxide, and mixtures thereof.

6. The catalyst according to claim 4, wherein said oxide other than zirconium oxide comprises silica.

7. The catalyst according to claim 1, wherein said platinum group metal, silver, gold, or a mixture thereof is present in an amount of from 0.001 to 10 wt. %, each based on the weight of the carrier.

8. The catalyst according to claim 1, being obtainable by depositing the metal selected from the group consisting of a platinum group metal, silver, gold, and a mixture thereof by dipping said carrier to a solution of halides of said metal followed by reduction.

9. The catalyst according to claim 8, wherein said reduction is carried out in the presence of a reducing agent.

10. The catalyst according to claim 1, wherein said carrier has an amorphous structure.

11. The catalyst according to claim 1, wherein said catalyst exhibits a BET value of greater than 20 m²/g.

12. (canceled)

13. A process for producing hydrogen peroxide, comprising: reacting hydrogen and oxygen in the presence of the catalyst according to claim 1 in a reactor.

14. The process for producing the catalyst according to claim 1, comprising:
(i) adding, to an oxide other than zirconium oxide, a precursor of zirconium oxide to form a homogeneous mixture,
(ii) converting said precursor to zirconium oxide to produce a carrier, and
(iii) depositing a platinum group metal, silver, gold, or a mixture thereof onto the carrier.

15. The process for producing the catalyst according to claim 14, wherein said precursor of a zirconium oxide is an oxyhalide of zirconium.

16. The catalyst according to claim 2, wherein said catalyst comprises palladium or a combination of palladium with gold, platinum or ruthenium.
